(19) United States
(12) Patent Application Publication
(10) Pub. No.: US 2005/0224096 A1
(43) Pub. Date: Oct. 13, 2005

(54) Method for cleaning fuel cell hose and fuel cell hose cleaned by the method

(75) Inventors: Takahiro Nishiyama, Kasugai-shi (JP); Ryo Hirai, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/091,750

(22) Filed: Mar. 29, 2005

(30) Foreign Application Priority Data
Mar. 29, 2004 (JP) JP2004-096795

(51) Int. Cl. B08B 9/02

(52) U.S. Cl. 134/22.1; 134/22.11; 134/22.14

(57) ABSTRACT

A method for cleaning a fuel cell hose by eliminating impurities efficiently in a short time by means of extraction without affecting physical properties of the hose, and a fuel cell hose cleaned by the method. The method is for cleaning a fuel cell hose containing a rubber layer and/or a resin layer and comprises the steps of supplying an oxygenated solvent into the hose and sealing the hose, or entirely impregnating the hose with the oxygenated solvent.

### BACKGROUND OF THE INVENTION

1. Field of the Invention

The present invention relates to a method for cleaning a fuel cell hose and a fuel cell hose cleaned by the method.

2. Description of the Art

It is generally understood that fuel cell systems, especially fuel cell systems using polymer electrolytes, will be widely accepted as future power generation systems. The energy generated by such fuel cell systems can very effectively be utilized, for example, for a power source for automobiles, domestic electricity and hot water. In the above-mentioned fuel cell systems, energy is generated by chemical reactions between hydrogen and oxygen by means of a catalyst. Therefore, if foreign matters such as catalyst poison (such as sulfur) or various ions are present in such a system, the foreign matters inhibit the chemical reactions and poison the catalyst, so that reaction efficiency is drastically deteriorated. For this reason, it is required that materials, from which such foreign matters may not be extracted and to which such foreign matters may not attached, be used for tubing materials (hose materials) and related parts in both inflow lines of hydrogen and oxygen.

To cool heat generated in the chemical reactions in the fuel cell system, a water-cooled system is usually provided. The cooling water (pure water and coolant) flowing through water-cooled lines thereof requires to maintain electrical isolation. If the cooling water assumes electrical conductivity, electrical short-circuiting tends to occur, which may cause an electrical shock or deteriorate power generation efficiency. In other words, ions should be difficult to be extracted from the tubing materials (hose materials) into cooling water flowing through the water-cooled lines so as not to increase electrical conductivity of the cooling water. Generally, pure water, having low electrical conductivity, or a mixture of pure water and coolant is used for the above-mentioned cooling water. However, pure water does not include any agent for bacteria elimination, such as chlorine. Therefore, if a great amount of low-molecular-weight organic matter is extracted from the tubing materials (hose materials), bacteria feeding on such organic matter may be massively generated.

Heretofore, under such circumstances, a stainless (SUS) tube has been used for the above-mentioned purposes in the fuel cell system because of its low ion dissolution. However, the SUS tube has poor bending workability due to its high rigidity. Therefore, it is difficult to mold the SUS tube and also difficult to assemble the SUS tube, which causes problems in terms of layout and workability. In addition, the SUS tube has a problem of poor vibration durability.

For this reason, a rubber hose formed by rubber such as ethylene-propylene-diene terpolymer (EPDM) has been recently used for the above-mentioned purposes. However, a mold release agent or the like, applied on an inner peripheral surface of such a rubber hose during the production process, remains as it is. Further, its rubber material contains a small amount of impurities such as metal ions, sulfur or low-molecular-weight organic matter, and also contains impurities originally contained in its rubber compound or impurities mixed therein during the production process of the hose. Since these impurities may be gradually extracted, the resulting hose cannot be used as it is for tubing of the fuel cell systems. Therefore, the inner peripheral surface of the hose should be cleaned during the production process. The process for cleaning the inner peripheral surface of the hose comprises, for example, the steps of cleaning the mold release agent attached to an inner peripheral surface of the hose by water or cleaning fluid, supplying pure water having specific conductivity of not more than 20 μS/cm into the hose, sealing the hose and conducting extraction for a long time (about 24 hours×2 cycles) with the water maintained at a high temperature (about 90° C.). Thereafter, the hose is cleaned with water and then dried. Thus, the hose is manufactured (see, for example, Japanese Unexamined Patent Publication Nos. 2003-173803 and 2002-81581).

However, the conventional process for cleaning impurities of the hose by means of extraction with pure water filled into the hose should be conducted at a high temperature for a long time, as described above, which is not preferred in terms of working efficiency and thus requires a solution. If the working efficiency of such cleaning process is prioritized, physical properties of the hose may be affected. Therefore, it is a current situation that there is no specific solution.

In view of the foregoing, it is an object of the present invention to provide a method for cleaning a fuel cell hose by eliminating impurities efficiently in a short time by means of extraction without affecting physical properties of the hose, and a fuel cell hose cleaned by the method.

### SUMMARY OF THE INVENTION

In accordance with a first aspect of the present invention to achieve the aforesaid objects, there is provided a method for cleaning a fuel cell hose containing a rubber layer and/or a resin layer, the method comprising the steps of supplying an oxygenated solvent into the fuel cell hose and sealing the fuel cell hose, or entirely impregnating the fuel cell hose with the oxygenated solvent. In accordance with a second aspect of the present invention, there is provided a fuel cell hose cleaned by the method according to the first aspect.

The inventors of the present invention conducted intensive studies to solve the above-mentioned problems centered upon cleaning fluid used for eliminating impurities inside a hose by means of extraction. Conventionally, pure water was thought to be the only one material as such fluid. It was technically common sense that an organic solvent is compatibilized with rubber (such as EPDM) as a hose material, so that the rubber swells and thus physical properties of the hose are deteriorated. As results of accumulated studies, they discovered that when an oxygenated solvent, such as alcohols and ketones, was used as an organic solvent, such an oxygenated solvent could remove impurities at a low temperature in a short time without deteriorating physical properties of the hose, although it requires a high-temperature and long-time treatment for removing such impurities with pure water. Thus, they attained the present invention.

The reason is thought to be as follows. Since the above-mentioned oxygenated solvent has relatively high polarity among organic solvents, the oxygenated solvent may not swell rubber unlike usual organic solvents, such as hydrocarbon solvents (for example, fatty acid hydrocarbons or aromatic hydrocarbons). Further, since the oxygenated solvent has small molecular weight and thus high osmotic force to rubber, the oxygenated solvent can easily go in and out of the rubber layer. It is thought that when the oxygenated solvent goes out of the rubber layer, the oxygenated solvent brings along impurities of the rubber layer, whereby impurities can be effectively taken out (extracted) from the rubber layer. Further, since the oxygenated solvent has an ability to dissolve organic matter and is also water soluble, it is easy to remove the oxygenated solvent after extraction. Further, the oxygenated solvent has high general versatility and has low effect on the environment.

As described above, according to the present invention, a hose (especially, a rubber layer thereof) is cleaned by supplying the oxygenated solvent into the fuel cell hose containing a rubber layer and/or a resin layer and sealing the hose for a predetermined time, or entirely impregnating the hose with the oxygenated solvent for a predetermined time, so that an objective hose is obtained. For this reason, according to this method, a hose can be cleaned efficiently at a low temperature in a short time without affecting physical properties of the hose. Further, various ions, which accelerate electrical conductivity of the fluid, as well as low-molecular-weight organic matter can be actively removed by this cleaning method. For this reason, impurities, various ions, sulfur, low-molecular-weight organic matter and the like may substantially be not extracted from the thus cleaned hose, which thus can be applied to various tubing in a fuel cell system. The use of the thus cleaned hose can prevent electrical short-circuiting in a fuel cell system due to increase of electrical conductivity of the fluid, deterioration in power generation efficiency due to poisoned catalyst and massive generation of bacteria due to extraction of low-molecular-weight organic matter into the fluid.

Especially, when the oxygenated solvent has a solubility parameter (SP value) of not less than 9 and a molecular weight of 30 to 120, cleaning effect of the present invention can be further increased.

When the oxygenated solvent is methyl ethyl ketone, ethanol, isopropanol or the like, extraction efficiency can be further increased, elimination of the solvent after extraction can be easier, and further the use of the solvent lowers bad effects on the environment.

When the cleaning by the sealing method or the impregnating method is an extraction treatment at an ordinary temperature to 60° C. within 24 hours, the extraction effect (cleaning effect) as same as or more than the conventional extraction of high-temperature and long-time treatment by means of pure water can be obtained without affecting physical properties of the hose.

### DESCRIPTION OF THE PREFERRED EMBODIMENTS

Embodiments of the present invention will hereinafter be described in detail.

As described above, according to the present invention, a hose (especially, a rubber layer thereof) is cleaned by supplying an oxygenated solvent into the fuel cell hose containing a rubber layer and/or a resin layer and sealing the hose for a predetermined time, or entirely impregnating the hose with the oxygenated solvent for a predetermined time, so that an objective hose is obtained. The “cleaning” herein means not only surface cleaning of an inner peripheral surface and an outer peripheral surface of the hose, but also cleaning inside each layer of the hose, i.e., elimination of minute amount of impurities by extraction.

The material for forming the rubber layer is not particularly limited. Examples thereof include ethylene-propylene-diene rubber (EPDM), chloroprene rubber (CR), acrylonitrile-butadiene rubber (NBR), NBR-polyvinyl chloride (PVC) blend rubber (NBR/PVC), hydrogenated NBR (H-NBR), acrylic rubber (ACM), ethylene acrylic rubber (AEM), epichlorohydrin rubber (ECO), chlorosulfonated polyethylene (CSM), chlorinated polyethylene rubber (CPE), butyl rubber (IIR), natural rubber (NR), isoprene rubber (IR), ethylene-propylene rubber (EPM) and silicone rubber (Q). These may be used either alone or in combination. Among them, EPDM is preferably used as a fuel cell hose. Further, a filler, such as carbon black and talc, a crosslinking agent, a co-crosslinking agent, process oil, an antioxidant and the like are appropriately blended, as required, in addition to the above-mentioned rubber.

Then, each component of the above is kneaded by means of a kneading machine such as a kneader, a Banbury mixer or a roll mill so as to prepare a rubber compound. Further, the thus obtained rubber compound is molded into a hose shape and the resulting mold is crosslinked entirely at specified conditions. Thus, the rubber hose used in the present invention can be obtained. In molding, a mandrel may be used, as required. The structure of the hose is not limited to a single-layer structure, and may be a two or multi-layer structure by forming another rubber layer, a resin layer or a reinforcing fiber layer.

Examples of the material for forming the resin layer include polyamide 6 (PA6), polyamide 66 (PA66), polyamide 11 (PA11), polyamide 12 (PA12), polypropylene (PP), polyethylene (PE), polyphenylene ether (PPE), polyphenylene sulfide (PPS), polyvinylidene fluoride resin (PVDF), polyoxymethylene (POM), polybutylene naphthalate (PBN), polybutylene terephthalate (PBT), polyethylene terephthalate (PET), polytetrafluoroethylene (PTFE) and an ethylene-tetrafluoroethylene copolymer (ETFE). These may be used either alone or in combination.

First, the thus obtained hose is appropriately cleaned by water or conventional cleaning fluid, especially superficially, with a focus on an inner peripheral surface of the hose. Thereafter, the thus treated hose is extracted for internal cleaning by supplying an oxygenated solvent into the hose and sealing the hose for a specified time or entirely impregnating the hose with the oxygenated solvent for a specified time. Herein, the above-mentioned cleaning by sealing may be conducted by supplying the oxygenated solvent into the hose and plugging two openings at both ends of the hose, or by connecting the hose with a circulating system and circulating the oxygenated solvent through the hose. Alternatively, when the hose is cleaned by impregnating the hose with the oxygenated solvent, it is required that the oxygenated solvent spread into every corner of the inner peripheral surface of the hose.

Examples of the oxygenated solvent include alcohol solvents, such as methanol, ethanol, propanol, isopropanol, butanol and isobutanol, ketone solvents, such as methyl ethyl ketone and acetone, ether solvents, such as ethyl ether, and ester solvents, such as ethyl acetate. These may be used either alone or in combination. Among all, methyl ethyl ketone, ethanol and isopropanol are preferred because of low cost, excellent extraction, easy elimination of these solvents after extraction, and low effect on the environment. Further, water (pure water) may be added to these solvents.

The oxygenated solvent preferably has a solubility parameter (SP value) of not less than 9 and a molecular weight of 30 to 120, because cleaning effect of the present invention is increased. More preferably, the SP value is 9.3 to 12.7 and the molecular weight is 40 to 80. When the molecular weight is too much lower than the above range, a boiling point of the solvent is too low and thus is easy to vaporize at about 40° C., which is difficult for working. To the contrary, when the molecular weight is too much higher than the above range, it is difficult for the solvent to enter the rubber layer and then to take out impurities. Even if the solvent can enter the rubber layer, it is difficult to take out the solvent from the rubber layer. Further, the solvent requires polarity so as not to swell rubber. Therefore, the solvent preferably has a SP value of not less than 9. Herein, the SP value indicates the polarity of the material and is obtained by the following formula (1). When the SP value of the solvent is further away from the SP value of the rubber layer of the hose to be cleaned, the compatibility is lowered therebetween, so that the rubber layer does not swell.

$$SP = \frac{Δ E}{V} \qquad ( 1 )$$

wherein ΔE indicates evaporation energy and V indicates molar volume.

When the oxygenated solvent is used as an organic solvent, such oxygenated solvent could remove impurities at a low temperature in a short time without deteriorating physical properties of the hose, although it requires a high-temperature and long-time treatment for removing such impurities with pure water. When the cleaning by the sealing method or the impregnating method is an extraction treatment at an ordinary temperature to 60° C. within 24 hours, the extraction effect (cleaning effect) as same as or more than the conventional extraction of high-temperature and long-time treatment by means of pure water can be obtained without affecting physical properties of the hose. Herein, “an ordinary temperature to 60° C.” means a range of about 10 to 60° C. This range means that cleaning effect is sufficiently expected if within this range. However, the above-mentioned extraction treatment does not exclude the treatment where the temperature or the time is not within the above-mentioned range. Further, to increase the cleaning effect, it is preferred to exchange the cleaning fluid (oxygenated solvent) once entirely in about 4 hours, and to clean the hose with the fresh solvent for not less than about 4 hours. The cleaned hose (fuel cell hose) can be obtained by conducting extraction treatment in this manner and drying the thus treated hose. The drying process is usually conducted at an ordinary temperature or with heat for 0.5 to 60 minutes. The drying process may be conducted by vacuum drying.

In the thus obtained hose, the thickness of an innermost layer (rubber layer) is not specifically limited, but is usually 1 to 12 mm. The inner diameter of the hose is usually 4 to 60 mm.

The application of the fuel cell hose of the present invention is not limited to the hose for use in fuel cell powered vehicles. For example, the hose of the present invention may be used as a hose for a household stationary fuel cell or a cooling hose for a computer.

Next, an explanation will be given for Examples of the present invention and for Comparative Examples.

### EXAMPLE 1

First, 100 parts by weight (just abbreviated to “parts”, hereinafter) of EPDM, 50 parts of SRF (Super Reinforcing Furnace) carbon black, 100 parts of white filler (precipitated whiting) , 50 parts of paraffin oil, 1 part of antioxidant (an aromatic secondary amine) and 5 parts of a peroxide crosslinking agent (PERCUMYL D available from NOF Corporation of Tokyo, Japan) were kneaded by a Banbury mixer and a roll mill for obtaining a rubber compound. The thus obtained rubber compound was extruded into a hose shape and was vulcanized at 160° C. for 45 minutes for obtaining a rubber hose having a single-layer structure (thickness of the layer: 4 mm, inner diameter of the hose: 30 mm). Then, isopropanol (boiling point: 82.4° C., specific gravity: 0.19 g/ml, SP value: 11.5) was supplied into the hose as cleaning fluid and was sealed, and then the hose was allowed to stand for 24 hours while the fluid temperature was maintained at 40° C. Thus, the inside of the hose was cleaned. After this cleaning treatment was completed, the hose was dried for obtaining the objective cleaned hose (fuel cell hose).

### EXAMPLES 2

An objective cleaned hose (fuel cell hose) was obtained in the same manner as in Example 1 except that the time for cleaning by sealing the hose into which the cleaning fluid was supplied (time for allowing to stand) was changed to 8 hours.

### EXAMPLE 3

An objective cleaned hose (fuel cell hose) was obtained in the same manner as in Example 1 except that ethanol (boiling point: 78.4° C., specific gravity: 0.79 g/ml, SP value: 12.7) was used as cleaning fluid.

### EXAMPLE 4

An objective cleaned hose (fuel cell hose) was obtained in the same manner as in Example 1 except that ethanol (boiling point: 78.4° C., specific gravity: 0.79 g/ml, SP value: 12.7) was used as cleaning fluid and the time for cleaning (time for allowing to stand) was changed to 8 hours.

### EXAMPLE 5

An objective cleaned hose (fuel cell hose) was obtained in the same manner as in Example 1 except that methyl ethyl ketone (boiling point: 79.6° C., specific gravity: 0.80 g/ml, SP value: 9.3) was used as cleaning fluid.

### EXAMPLE 6

An objective cleaned hose (fuel cell hose) was obtained in the same manner as in Example 1 except that methyl ethyl ketone (boiling point: 79.6° C., specific gravity: 0.80 g/ml, SP value: 9.3) was used as cleaning fluid and the time for cleaning (time for allowing to stand) was changed to 8 hours.

### COMPARATIVE EXAMPLE

An objective cleaned hose (fuel cell hose) was obtained in the same manner as in Example 1 except that pure water (boiling point: 100.0° C., specific gravity: 1.00 g/ml, SP value: 23.4) was used as cleaning fluid and the time for cleaning (time for allowing to stand) was changed to 8 hours.

### CONVENTIONAL EXAMPLE

An objective cleaned hose (fuel cell hose) was obtained in the same manner as in Example 1 except that pure water (boiling point: 100.0° C., specific gravity: 1.00 g/ml, SP value: 23.4) was used as cleaning fluid and the cleaning fluid was maintained at 80° C. during cleaning an inner peripheral surface of the hose.

Properties of the hoses thus produced in accordance with the Examples, the Comparative Example and the Conventional Example were evaluated in the following manners. The results of the evaluations are also shown in Tables 1 and 2.

Electrical Conductivity of Solution

Each hose was filled with pure water (specific conductivity: 1 μS/cm) and sealed by plugging two openings at both ends of the hose with SUS metals. After each hose was thermally aged at 100° C. for 24 hours, pure water filled therein was removed. This procedure was repeated again as a second cycle. Each electrical conductivity (μS/cm) of pure water removed at the first cycle and the second cycle was measured at 25° C. by means of CONDUCTIVITYMETER D-24 available from HORIBA, Ltd. of Kyoto, Japan.

Total Organic Carbon Weight of Solution (TOC Weight)

After 10 test pieces having dimensions of 2.8 mm×2.8 mm×2 mm were respectively cut out of each hose and were immersed in 100 ml of pure water (specific conductivity: 1 μS/cm) at 100° C. for 24 hours for thermal aging, pure water was exchanged. This procedure was repeated again as a second cycle. The total organic carbon weight (μg/cm² sample) of pure water after the completion of the second cycle was measured in accordance with Japanese Industrial Standards (JIS) K 0102 22.1.

Tensile Strength at Break (TB) and Elongation at Break (EB)

A sample having a thickness of 2 mm was cut out of each hose, and then was stamped to provide a No. 5 dumbbell specimen in accordance with Japanese Industrial Standards. The tensile strength at break (TB) and elongation at break (EB) of the specimen were determined in conformity with JIS K 6251. In evaluation of the tensile strength at break (TB), the value of not less than 8 MPa was regarded as good (∘). In evaluation of the elongation at break (EB), the value of not less than 200% was regarded as good (∘).

Sealing Property

After both ends of each hose were connected with metallic pipes (caps), each hose was filled with water. When a pressure of 0.2 MPa was applied to the water from one end of the hose, the connected portion between the cap and the hose was visually checked about whether water leakage occurred. The hose where no abnormalities such as water bleeding or water leakage occurred was evaluated as good (∘).

Pressure Resistance Property

One end of each hose was plugged and the other end of the hose was connected with a hydraulic pump for applying hydraulic pressure of 1 MPa to the hose. The hose which caused no leakage and no rupture with the load of such pressure was evaluated as good (∘).

Flexibility

Each hose was wrapped around a mandrel having an outer diameter of five times larger than that of the hose. At that time, a hose which was easy to be wrapped was evaluated as good (∘).

Resistance

The volume resistivity of each hose was measured in accordance with JIS K 6911. The hose having a value of not less than 10⁶ Ω·cm was evaluated as good (∘).

Insertability

One end of a metallic pipe having an outer diameter of 31 mm was inserted into one end of a hose having a length of 20 cm. The other end of the hose was pressed toward a side of the metallic pipe by means of a load cell at a rate of 25 mm/min in such a state until the distance of the portion to be inserted was 28 mm. The load was measured during the process by means of an autograph (AG-1000D available from Shimadzu Corporation of Kyoto, Japan). The hose having a maximum value of less than 180N was evaluated as good (∘).

Heat Resistance

Each hose was subjected to heat treatment of 120° C. for 168 hours. Thereafter, one end of the hose was plugged while the other end of the hose was connected with a hydraulic pump for applying hydraulic pressure of 1 MPa to the hose. The hose which caused no leakage and no rupture with the load of such pressure was evaluated as good (∘).

TABLE 1

| | Electrical conductivity | | |
|---|---|---|---|
| | of solution (μS/cm) | | TOC weight of solution |
| | First cycle | Second cycle | (μg/cm² sample) |
| EXAMPLE 1 | 19.5 | 14.0 | 14.1 |
| EXAMPLE 2 | 25.3 | 18.5 | 16.2 |
| EXAMPLE 3 | 18.1 | 13.4 | 13.5 |
| EXAMPLE 4 | 23.1 | 17.3 | 16.2 |
| EXAMPLE 5 | 55.1 | 35.8 | 6.9 |
| EXAMPLE 6 | 52.1 | 34.4 | 8.3 |
| COMPARATIVE | 75.5 | 45.3 | 32.7 |
| EXAMPLE | | | |
| CONVENTIONAL | 60.8 | 37.1 | 27.6 |
| EXAMPLE | | | |

TABLE 2

| EXAMPLE | | | | | | COMPARATIVE | CONVENTIONAL |
|---|---|---|---|---|---|---|---|
| 1 | 2 | 3 | 4 | 5 | 6 | EXAMPLE | EXAMPLE |

Physical properties of hose

| | | | | | | | | |
|---|---|---|---|---|---|---|---|---|
| TB | ◯ | ◯ | ◯ | ◯ | ◯ | ◯ | ◯ | ◯ |
| EB | ◯ | ◯ | ◯ | ◯ | ◯ | ◯ | ◯ | ◯ |
| Sealing property | ◯ | ◯ | ◯ | ◯ | ◯ | ◯ | ◯ | ◯ |
| Pressure resistance property | ◯ | ◯ | ◯ | ◯ | ◯ | ◯ | ◯ | ◯ |
| Flexibility | ◯ | ◯ | ◯ | ◯ | ◯ | ◯ | ◯ | ◯ |
| Resistance | ◯ | ◯ | ◯ | ◯ | ◯ | ◯ | ◯ | ◯ |
| Insertability | ◯ | ◯ | ◯ | ◯ | ◯ | ◯ | ◯ | ◯ |
| Heat resistance | ◯ | ◯ | ◯ | ◯ | ◯ | ◯ | ◯ | ◯ |

As can be understood from the above results, each Example had suppressed electrical conductivity of solution and suppressed TOC weight of solution as compared with the Comparative Example. Therefore, each Example had extremely small amount of extraction of electrically conductive material and low-molecular-weight organic matter. The amount of such extraction of each Example was suppressed as low as or less than the Conventional Example where extraction was conducted at a high temperature for a long time. Further, each Example had good results for a series of physical properties similarly as the Comparative Example and the Conventional Example both where extraction was conducted using pure water.

The application of the fuel cell hose of the present invention is not limited to the hose for use in fuel cell powered vehicles. For example, the hose of the present invention may be used as a hose for a household stationary fuel cell or a cooling hose for a computer.

1. A method for cleaning a fuel cell hose containing a rubber layer and/or a resin layer, the method comprising the steps of:
supplying an oxygenated solvent into the hose and sealing the hose, or
entirely impregnating the hose with the oxygenated solvent.

2. A method as set forth in claim 1, wherein the oxygenated solvent has a solubility parameter (SP value) of not less than 9 and a molecular weight of 30 to 120.

3. A method as set forth in claim 1, wherein the oxygenated solvent is at least one solvent selected from the group consisting of methyl ethyl ketone, ethanol and isopropanol.

4. A method as set forth in claim 2, wherein the oxygenated solvent is at least one solvent selected from the group consisting of methyl ethyl ketone, ethanol and isopropanol.

5. A method as set forth in claim 1, wherein the cleaning by sealing the hose into which the oxygenated solvent is supplied or by impregnating the hose with the oxygenated solvent is an extraction treatment at an ordinary temperature to 60° C. within 24 hours.

6. A method as set forth in claim 2, wherein the cleaning by sealing the hose into which the oxygenated solvent is supplied or by impregnating the hose with the oxygenated solvent is an extraction treatment at an ordinary temperature to 60° C. within 24 hours.

7. A method as set forth in claim 3, wherein the cleaning by sealing the hose into which the oxygenated solvent is supplied or by impregnating the hose with the oxygenated solvent is an extraction treatment at an ordinary temperature to 60° C. within 24 hours.

8. A method as set forth in claim 4, wherein the cleaning by sealing the hose into which the oxygenated solvent is supplied or by impregnating the hose with the oxygenated solvent is an extraction treatment at an ordinary temperature to 60° C. within 24 hours.

9. A fuel cell hose cleaned by a method as set forth in claim 1.

10. A fuel cell hose cleaned by a method as set forth in claim 2.

11. A fuel cell hose cleaned by a method as set forth in claim 3.

12. A fuel cell hose cleaned by a method as set forth in claim 4.

13. A fuel cell hose cleaned by a method as set forth in claim 5.

14. A fuel cell hose cleaned by a method as set forth in claim 6.

15. A fuel cell hose cleaned by a method as set forth in claim 7.

16. A fuel cell hose cleaned by a method as set forth in claim 8.
